(19) United States
(12) Patent Application Publication
(10) Pub. No.: US 2011/0010217 A1
(43) Pub. Date: Jan. 13, 2011

(54) Service Oriented Architecture Governance Using A Template

(75) Inventors: Majeed M. Arni, Austin, TX (US); Peter A. Coldicott, Leander, TX (US); Eduardo T. Kahan, Longwood, FL (US); Mei Y. Selvage, Pocatello, ID (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/502,010

(22) Filed: Jul. 13, 2009

(51) Int. Cl. G06Q 10/00; G06F 3/048

(52) U.S. Cl. 705/8; 705/7; 715/763

(57) ABSTRACT

Embodiments of the invention are directed to establishing a governance procedure for a selected service oriented architecture. One embodiment of the invention, directed to a method, comprises the steps of furnishing one or more first governance tasks, and furnishing one or more second governance tasks. The method further comprises providing a user of the governance procedure with a template, wherein the template is configured for operation by the user to selectively modify at least one of the first governance tasks. The template is configured further to be incapable of modifying any of the second governance tasks, when the template is being operated by the user. Each modified first governance task is combined with each of the second governance tasks, and also with each unmodified first governance task, to provide the governance procedure.

The present Application is related to the following co-pending applications: U.S. patent application Ser. No. ______, filed on ______, to Arni et al., entitled “SYSTEM FOR MANAGING EVENTS IN A CONFIGURATION OF SOA GOVERNANCE COMPONENTS”; U.S. patent application Ser. No. ______, filed on ______, to Arni et al., entitled “AUTOMATED REACTIVE BUSINESS PROCESSES”, all assigned to the present assignee, and all incorporated herein by reference.

### BACKGROUND

The disclosure relates generally to a method associated with the governance or governance flow for a service oriented architecture (SOA), and more specifically to SOA governance parameters that can be readily adjusted or adapted, in order to meet the needs of different SOA customers or other users.

As is known by those of skill in the art, SOA is generally directed to the development of systems that typically group functionality around multiple business processes or the like, in order to provide configurations of interoperable services. SOA infrastructure enables different applications to exchange data with one another, where the applications pertain to different business processes, and respective functions in the SOA are separated into distinct units or services. Various developers and vendors make a number of different services available over a network. Users are thus enabled to access a variety of services, and combine them together in coordinated relationships.

SOA governance pertains to a set of tasks, processes or activities that are put in place to exercise control over the respective services of an SOA. A stream of such SOA tasks or processes can be referred to as governance flow. Generally, the focus of governance is to deploy and use the SOA to achieve goals and objectives of a particular business entity or other SOA user. However, different users will typically have different business requirements, growing out of factors such as their individual IT challenges, existing technologies, end users and corporate cultures. They will also have different SOA requirements, such as SOA maturity, entry points and life cycle.

In view of these different user requirements, there is a corresponding need for different SOA governance products. However, currently available SOA products are largely inadequate to allow customers or other users to perform customization of SOA governance flows. Some of such products are hardcoded, and have built-in SOA governance flows. While some of these products may allow customer adjustment of certain parameters, it is highly impractical for SOA governance solution vendors to parameterize all the combinations of variables that are encountered in the present customer environment, which is vast and diverse.

In some arrangements, enterprise archive (EAR) files are generated and deployed, in order to provide specified SOA governance flows. If a user requires a different SOA governance, a different EAR file may be needed to provide each different governance. Also, if user conditions change and a new governance flow is needed, it may be necessary to generate and deploy a new EAR file. This is generally undesirable, since the creation and use of EAR files can involve substantial cost and effort.

The effective use of SOA governance requires that monitoring, auditing and measuring activities must be frequently carried out, in order to determine whether or not policies specified by the governance are being adhered to. However, governance activities of these types are presently performed in manual form, such as by means of Word documents, Power Points and Visio diagrams. Tools such as these have limited capability for enforcement and monitoring. For example, such tools make it is necessary to monitor textual material, but text very frequently has multiple interpretations. Also, linkages to different steps must generally be made manually.

### SUMMARY

Embodiments of the invention are directed to establishing a governance procedure for a selected service oriented architecture. One embodiment of the invention, directed to a method, comprises the steps of furnishing one or more first governance tasks, and furnishing one or more second governance tasks. The method further comprises providing a user of the governance procedure with a template, wherein the template is configured for operation by the user to selectively modify at least one of the first governance tasks. The template is configured further to be incapable of modifying any of the second governance tasks, when the template is being operated by the user. Each modified first governance task is combined with each of the second governance tasks, and also with each unmodified first governance task, to provide the governance procedure.

### BRIEF DESCRIPTION OF THE SEVERAL VIEWS OF THE DRAWINGS

FIG. 1 is a schematic diagram illustrating an embodiment of the invention.

FIG. 2 is a schematic diagram further illustrating an embodiment of the invention.

FIG. 3 is a flow chart showing steps of a method comprising an embodiment of the invention.

FIG. 4 is a block diagram showing a network of data processing systems that may be used in implementing embodiments of the invention.

FIG. 5 is a block diagram showing a computer or data processing system that may be used in implementing embodiments of the invention.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

As used herein, the terms SOA governance product, governance procedure, and governance flow are equivalent and may be used interchangeably. Each of these terms is defined to be a stream, sequence or other specified arrangement of tasks or processes, wherein the tasks or processes are used collectively to provide direction for or to exercise control over the services of an SOA. As described above, there is a growing need for tools that will make it easier for SOA users to modify or customize SOA governance products supplied by vendors. In order to achieve this objective, embodiments of the invention provide templates that identify particular tasks of an SOA governance procedure that are fixed and unchangeable, and other tasks which can be changed by a user. As described hereinafter in further detail, an embodiment of the invention may provide sets of universal state machine templates that can be readily customized by a user, in order to meet a wide range of requirements. These state machine templates are usefully provided in a logical form.

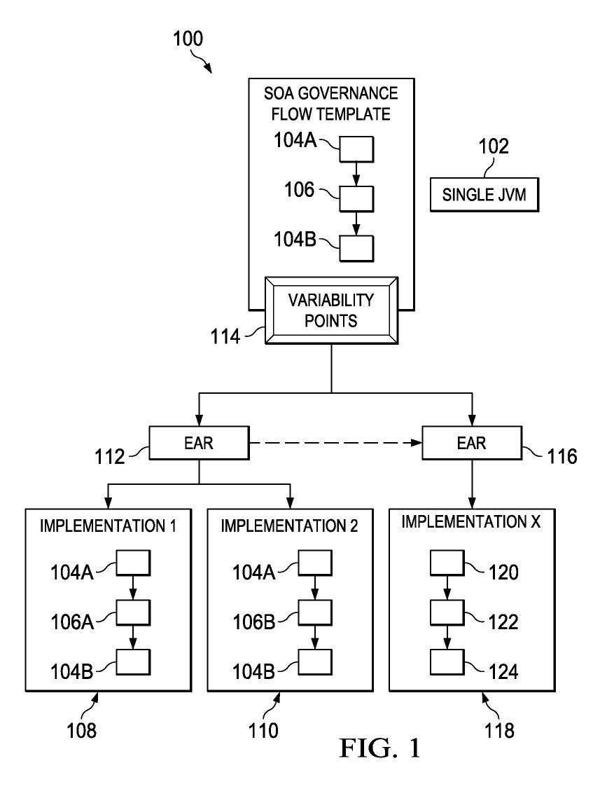

Referring to FIG. 1, there is shown an SOA governance flow template 100, in accordance with an embodiment of the invention. Template 100 depicts a number of tasks or processes and their flow or arrangement, for an associated SOA governance product or procedure (not shown). Template 100 is usefully provided by a single Java Virtual Machine (JVM) 102 and comprises software components as described hereinafter, wherein some of the components may be employed or operated by users to selectively change the associated governance product. Template 100 includes components 104A and 104B, and further includes a component 106.

Components 104A and 104B generically represent tasks or service operations that are initially specified by the SOA governance product vendor, and are intended to be implemented by the vendor only. Accordingly, the tasks of components 104A and 104B cannot be changed by the customer or other user, and will continue to consistently define mandatory SOA governance processes. For example, tasks of these components remain in control of version management, and ensure maintainability and compatibility for future releases. Tasks generically represented by components 104A and 104B are also generically referred to in this application as second governance tasks.

In contrast to components 104A and 104B, component 106 generically represents tasks or processes that can be modified by the user. For example, component 106 may include software that enables a user to select either of two pre-defined tasks or sub-flows, which are shown in FIG. 1 as 106A and 106B for the SOA governance flow associated with template 100. If the user selects task 106A, a subsequent implementation 108, also referred to as Implementation 1, is produced. Alternatively, if the user selects task 106B, a subsequent implementation 110, also referred to as Implementation 2, is produced. Tasks generically represented by components 106 are also generically referred to in this application as first governance tasks.

As an illustrative example, component 106 could pertain to a task or process for detecting an increase in the cost of a service included in the SOA. In response to detecting the cost increase, component 106 would enable the user to select one of the optional tasks 106A and 106B, and would implement the selected task. For example, optional task 106A could be to send an email to a specified person that only provided notice of the cost increase. On the other hand, optional task 106B would send an email or other notification of the cost increase to an SOA authority, together with a recommendation for a particular course of action to follow in response to the increase.

It is to be appreciated that component 106 could provide the user with a substantial number of tasks, together with multiple options for each task, in addition to the task and options 106A and 106B, as described above.

Referring further to FIG. 1, it is seen that both of the implementations 108 and 110 are provided by a single EAR file 112. Thus, it is necessary to generate and employ only a single EAR file, in order to implement all the options made available to a user by component 106. The use of only a single EAR file generally reduces errors and maintenance overhead, and speeds up implementation.

FIG. 1 shows EAR file 112 linked to template 100 by means of variability points 114. The variability points comprise a software component that enables the SOA governance procedure to be changed with comparative ease, and thus enhances flexibility. The variability points use open and industry standards, such as Web service or service component architecture (SCA), and are readily adaptable to the products of different vendors.

It may happen that a user of template 100 will require the performance of more complex and customized SOA governance tasks or processes than component 106 can provide. In this event, the user can implement the required complex process by constructing an additional EAR file 116, which is linked to variability points 114. The implementation may be carried out using language such as business process execution language (BPEL). FIG. 1 shows the resulting implementation 118, also referred to as Implementation X. Ear 112 can be configured to call the process of Implementation X, through EAR 116, by using SCA binding or Web service.

As an example of a need for EAR 116, a user could be required by the SOA governance to take some fairly complex measures in response to an increase in the cost of an SOA service. Thus, in response to the increase it would be necessary to automatically determine certain impacts of the cost increase over a specified period of time. It could also be necessary to automatically search for an equivalent service provided by a different vendor, at a cost that was less than the increased cost. Tasks such as these could be carried out by means of EAR 116 and Implementation X.

As described above, component 106 comprises a software component included in template 100 which enables a user to select certain SOA governance options. To further enhance customization and adaptation of SOA governance flow, an embodiment of the invention provides a set of universal state machine templates, which usefully are in logical form. In some embodiments, the set of templates is retained in a library. Each template provides options that can be pre-selected by a user, based on particular user requirements. Then, in response to occurrence of a specified actual event, one of the templates is used to perform one or more tasks at component 106 of governance flow template 100, wherein performance is in accordance with the pre-selected options.

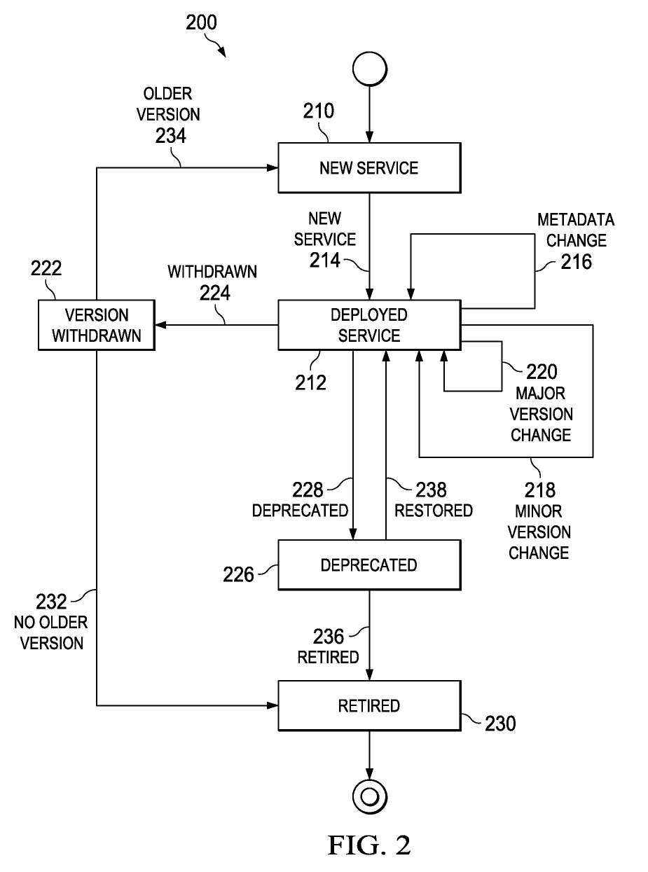

Referring to FIG. 2, there is shown an exemplary universal state machine template 200 of the type referred to above. More particularly, template 200 depicts a number of states, wherein the states pertains to a particular service of an associated SOA. Template 200 further shows a number of transition events that are likely to occur. In response to at least some of the transition events, certain ones of a multiplicity of tasks or processes will be carried out. Based on the requirements of a given user, the user may adapt the template 200 to select particular tasks or processes to meet the requirements.

FIG. 2 shows that processes of template 200 may commence when a new service state 210 occurs. This event occurs, for example, when a new version for one of the services of the associated SOA is received. If the new service version is deployed in the SOA at state 212, a new service state to state transition 214 occurs. Each transition of universal template 200 corresponds to a templatized process, and different combinations of processes can be selected by different users.

A number of these processes are shown in connection with deployed service state 212 of FIG. 2. For example, if the only difference between the new service and the previous version is a change in cost, the state transition is a metadata change 216, which loops from state 212 back to state 212. Changes 218 and 220 are likewise closed loop transitions, from state 212 back to state 212. Transition 218 occurs if the new service version provides only a minor change over the previous version which it replaces. On the other hand, transition 220 occurs if the new service version provides a substantial change over the previous version.

FIG. 2 further shows that one of two tasks can be performed in regard to the previous version at state 212. The previous version could be withdrawn, as shown by state 222, whereupon a withdrawn transition 224 occurs. Alternatively, the previous version could be moved from state 212 to deprecated state 226, so that a deprecated transition 228 occurs. The particular transition from state 212 that actually occurs could be pre-determined or pre-selected by prior user action.

As further shown by FIG. 2, if the previous service version is moved to state 222, one of two tasks can be performed. If it was recognized that the previous version was the oldest version of the service, it could be moved to state 230 and retired, so that state transition 232 occurs. On the other hand, if the previous version was not the oldest version, it may be moved to new service state 210 by a transition 234.

If the previous version is moved to deprecated state 226, one of two tasks again can be performed. Specifically, the previous version could be retired by moving it to state 230, so that a transition 236 occurs. Alternatively, the version could be restored and moved back to deployed state 212, as shown by transition 238.

In embodiments of the invention, generic SOA governance templates are linked to specific real SOA governance products. Unlike prior art approaches that use Visio diagrams, PowerPoint or the like, software components of the templates can be readily implemented in programs. The templates significantly increase the speed of implementation and reduce the numbers of deployments. They also automate integration among multiple SOA governance components and products, and make it easy to selectively add or remove unanticipated SOA governance components and products.

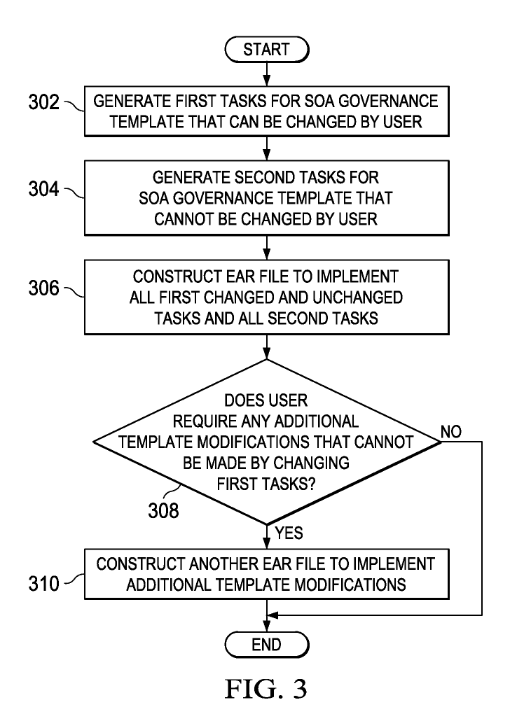

Referring to FIG. 3, there is shown a flowchart depicting steps for a method comprising an embodiment of the invention. At step 302, a number of first tasks are generated or otherwise provided for SOA governance template flow. One or more of the first tasks can be selectively changed by a user of the SOA, as described above. At step 304, a number of second tasks are generated for the template, wherein none of the second tasks can be changed by the user. An EAR file is constructed at step 306, in order to implement all first changed and unchanged tasks, and all second tasks.

Referring further to FIG. 3, step 308 queries whether or not the user requires any modifications to the template that cannot be made by changes to the first tasks. If not, the method of FIG. 3 ends. Otherwise, the method proceeds to step 310, which pertains to construction of another EAR file in order to implement the additional template modifications.

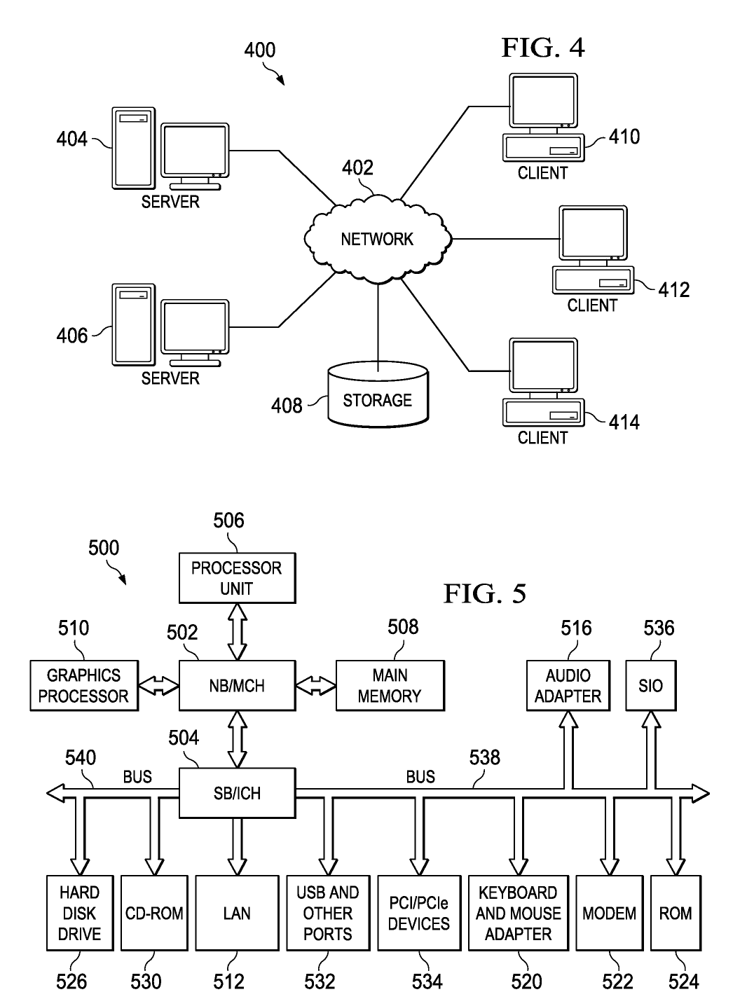

Referring to FIG. 4, there is shown a pictorial representation of a network of computers or data processing systems in which embodiments of the present invention may be implemented. One or more of these computers or data processing systems may provide respective services for an SOA associated with embodiments of the invention. Network data processing system 400 may include additional servers, clients, and other devices not shown. Network data processing system 400 contains a network 402, which is the medium used to provide communication links between various devices and computers connected together within network data processing system 400. Network 402 may include connections, such as wire, wireless communication links, or fiber optic cables.

In the depicted example, server 404 and server 406 connect to network 402 along with storage unit 408. In addition, clients 410, 412, and 414 connect to network 402. These clients 410, 412, and 414 may be, for example, personal computers or network computers. In the depicted example, server 404 provides data, such as boot files, operating system images, and applications to clients 410, 412, and 414. Clients 410, 412, and 414 are clients to server 404 in this example.

In the depicted example, network data processing system 400 is the Internet, with network 402 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 400 also may be implemented as a number of different types of networks, such as for example, an intranet, a local area network (LAN), or a wide area network (WAN). FIG. 4 is intended as an example, and not as an architectural limitation for different embodiments of the present invention.

Referring to FIG. 5, there is shown a data processing system 500 that may be used in implementing embodiments of the invention. Data processing system 500 is an example of a computer, such as server 404 or client 410 in FIG. 4, in which computer usable code or instructions implementing the processes for embodiments of the present invention may be located.

Data processing system 500 employs a hub architecture including north bridge and memory controller hub (MCH) 502 and south bridge and input/output (I/O) controller hub (ICH) 504. Processing unit 506, main memory 508, and graphics processor 510 are connected to north bridge and memory controller hub 502. Graphics processor 510 may be connected to north bridge and memory controller hub 502 through an accelerated graphics port (AGP).

In data processing system 500, local area network (LAN) adapter 512 connects to south bridge and I/O controller hub 504. Audio adapter 516, keyboard and mouse adapter 520, modem 522, read only memory (ROM) 524, hard disk drive (HDD) 526, CD-ROM drive 530, universal serial bus (USB) ports and other communications ports 532, and PCI/PCIe devices 534 connect to south bridge and I/O controller hub 504 through bus 538 and bus 540. PCI/PCIe devices may include, for example, Ethernet adapters, add-in cards and PC cards for notebook computers. PCI uses a card bus controller, while PCIe does not. ROM 524 may be, for example, a flash binary input/output system (BIOS).

Hard disk drive 526 and CD-ROM drive 530 connect to south bridge and I/O controller hub 504 through bus 540. Hard disk drive 526 and CD-ROM drive 530 may use, for example, an integrated drive electronics (IDE) or serial advanced technology attachment (SATA) interface. Super I/O (SIO) device 236 may be connected to south bridge and I/O controller hub 504.

An operating system runs on processing unit 506 and coordinates and provides control of various components within data processing system 500 in FIG. 5. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 500 (Java is a trademark of Sun Microsystems, Inc. in the United States, other countries, or both).

As a server, data processing system 500 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 500 may be a symmetric multiprocessor (SMP) system including a plurality of processors in processing unit 506. Alternatively, a single processor system may be employed.

Instructions for the operating system, the object-oriented programming system, and applications or programs are located on storage devices, such as hard disk drive 526, and may be loaded into main memory 508 for execution by processing unit 506. The processes for embodiments of the present invention are performed by processing unit 506 using computer usable program code, which may be located in a memory such as, for example, main memory 508, read only memory 524, or in one or more peripheral devices 526 and 530.

A bus system may be comprised of one or more buses, such as bus 538 or bus 540 as shown in FIG. 5. Of course the bus system may be implemented using any type of communications fabric or architecture that provides for a transfer of data between different components or devices attached to the fabric or architecture. A communications unit may include one or more devices used to transmit and receive data, such as modem 522 or network adapter 512 of FIG. 5. A memory may be, for example, main memory 508, read only memory 524, or a cache such as found in north bridge and memory controller hub 502 in FIG. 5. Examples depicted by FIGS. 1 and 2 and any other examples described herein are not meant to imply architectural limitations. For example, data processing system 500 also may be a tablet computer, laptop computer, or telephone device in addition to taking the form of a PDA.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for establishing a governance procedure for a selected service oriented architecture (SOA), said method comprising the steps of:
furnishing one or more first governance tasks;
furnishing one or more second governance tasks;
providing a user of said governance procedure with a template, wherein said template is configured for operation by said user to selectively modify at least one of said first governance tasks, and is configured further to be incapable of modifying any of said second governance tasks when said template is operated by said user; and
selectively combining each modified first governance task with each of said second governance task and with each unmodified first governance task to provide said governance procedure.

2. The method of claim 1, wherein:
said template is associated with a first enterprise archive (EAR) file that enables said user to selectively modify each of said first governance tasks.

3. The method of claim 2, wherein:
said first EAR file is linked to said template by means of one or more variability points.

4. The method of claim 1, wherein:
a second EAR file is linked to said template by means of said one or more variability points, wherein said second EAR file makes one or more modifications of said governance procedure, including a modification to at least one of said second governance tasks.

5. The method of claim 1, wherein:
said template is selected from a plurality of governance flow templates that are respectively associated with said SOA, and are each contained in an SOA governance library.

6. The method of claim 5, wherein:
said library includes a plurality of state machine templates, wherein each of said state machine templates enables said user to modify at least one task that is included in said governance procedure.

7. The method of claim 6, wherein:
a particular one of said tasks is triggered by the transition of a specified service from one state to another state.

8. The method of claim 7, wherein:
said service comprises a Web service.

9. The method of claim 7, wherein:
the specified service is a service that is newly added to the SOA, or a prior version of the service, selectively.

10. The method of claim 7, wherein:
said transition comprises an event selected from a group of events that include deprecating, restarting, withdrawing and restoring said specified service.

11. A computer program product executable in a computer readable medium for establishing a governance procedure for a selected service oriented architecture (SOA), said computer program product comprising:
instructions for furnishing one or more first governance tasks;
instructions for furnishing one or more second governance tasks;
instructions for providing a user of said governance procedure with a template, wherein said template is configured for operation by said user to selectively modify at least one of said first governance tasks, and is configured further to be incapable of modifying any of said second governance tasks when said template is operated by said user; and
instructions for selectively combining each modified first governance task with each of said second governance task and with each unmodified first governance task to provide said governance procedure.

12. The computer program product of claim 11, wherein:
said template is associated with a first enterprise archive (EAR) file that enables said user to selectively modify each of said first governance tasks.

13. The computer program product of claim 12, wherein:
said first EAR file is linked to said template by means of one or more variability points.

14. The computer program product of claim 11, wherein:
a second EAR file is linked to said template by means of said one or more variability points, wherein said second EAR file makes one or more modifications of said governance procedure, including a modification to at least one of said second governance tasks.

15. The computer program product of claim 11, wherein:
said template is selected from a plurality of governance flow templates that are respectively associated with said SOA, and are each contained in an SOA governance library, wherein said library includes a plurality of state machine templates, and each of said state machine templates enables said user to modify at least one task that is included in said governance procedure.

16. Apparatus for establishing a governance procedure for a selected service oriented architecture (SOA), said apparatus comprising
means for furnishing one or more first governance tasks;
means for furnishing one or more second governance tasks;
means for providing a user of said governance procedure with a template, wherein said template is configured for operation by said user to selectively modify at least one of said first governance tasks, and is configured further to be incapable of modifying any of said second governance tasks when said template is operated by said user; and
means for selectively combining each modified first governance task with each of said second governance task and with each unmodified first governance task to provide said governance procedure.

17. The apparatus of claim 16, wherein:
said template is associated with a first enterprise archive (EAR) file that enables said user to selectively modify each of said first governance tasks.

18. The apparatus of claim 17, wherein:
said first EAR file is linked to said template by means of one or more variability points.

19. The apparatus of claim 16, wherein:
a second EAR file is linked to said template by means of said one or more variability points, wherein said second EAR file makes one or more modifications of said governance procedure, including a modification to at least one of said second governance tasks.

20. The apparatus of claim 16, wherein:
said template is selected from a plurality of governance flow templates that are respectively associated with said SOA, and are each contained in an SOA governance library, wherein, said library includes a plurality of state machine templates, and each of said state machine templates enables said user to modify at least one task that is included in said governance procedure.
